(19) United States
(12) Patent Application Publication
(10) Pub. No.: US 2021/0017455 A1
(43) Pub. Date: Jan. 21, 2021

(54) CRUDE OIL UPGRADING

(71) Applicant: ExxonMobil Research and Engineering Company, Annandale, NJ (US)

(72) Inventor: Mohsen N. Harandi, New Hope, PA (US)

(21) Appl. No.: 16/930,894

(22) Filed: Jul. 16, 2020

Related U.S. Application Data
(60) Provisional application No. 62/875,159, filed on Jul. 17, 2019.

(51) Int. Cl. C10G 7/06; C10G 53/02; C10C 3/06; B01D 3/14; B01D 3/38

(52) U.S. Cl. CPC C10G 7/06; C10G 53/02; B01D 3/38; B01D 3/143; C10C 3/06

(57) ABSTRACT

Systems and processes are provided for upgrading a crude oil. In some examples, a heated crude oil can be introduced into an atmospheric distillation column where an overhead gas product comprising C₄₋ hydrocarbons can be recovered and recycled back to the atmospheric distillation column to decrease the partial pressure of the C₅₊ hydrocarbons in the distillation column allowing higher boiling point fractions of crude oil to be vaporized and recovered.

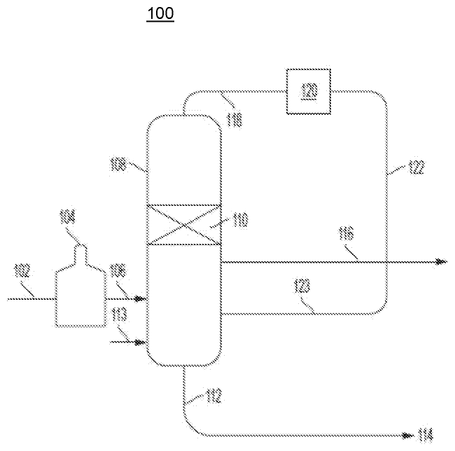

### CROSS REFERENCE TO RELATED APPLICATIONS

This application claims priority to U. S. Provisional Application Ser. No. 62/875,159 filed Jul. 17, 2019, which is herein incorporated by reference in its entirety.

### FIELD

This invention relates to a process for upgrading a crude oil. More particularly, this invention relates to upgrading a crude oil in an atmospheric distillation column by recycling at least a portion of an overhead gas product back to the atmospheric distillation column.

### BACKGROUND

There has been an increase in the use of heavy hydrocarbons such as those extracted from oil sands. These heavy hydrocarbons typically are geographically located in regions remote from refineries that can process them. Consequently, the hydrocarbons need to be transported to a refinery, most usually through a pipeline.

Presently the most convenient method for pipelining heavy hydrocarbons is by mixing the hydrocarbon with a diluent such as natural gas condensate to lower the viscosity and density of the hydrocarbon to render it suitable for pipelining. Experience has shown, however, that in order to meet the pipeline viscosity specifications, more diluent is used than is necessary to meet the density specifications.

There remains a need for an improved method for rendering heavy hydrocarbons pipelineable while using reduced amounts of diluent.

### SUMMARY

In some examples, a process for upgrading a crude oil is provided. The process can include heating a crude oil in a furnace to produce a heated crude oil. The heated crude oil can be introduced into a first inlet of an atmospheric distillation column having an absolute pressure of at least 17 kPa. An overhead gas product comprising C₄₋ hydrocarbons can be recovered from a first outlet of the atmospheric distillation column and at least a portion of the overhead gas product can be recycled to the atmospheric distillation column. Additionally, a bottoms product can be recovered from a second outlet of the atmospheric distillation column and a liquid hydrocarbon product can be recovered from a third outlet of the atmospheric distillation column. The third outlet can be located between the first and second outlet.

In some examples, a system for fractionation of a crude oil is provided. The system can include an atmospheric distillation column having an absolute operating pressure of 17 kPa or more. The atmospheric distillation column can include a first inlet in fluid communication with a furnace configured to introduce a heated crude oil into the atmospheric distillation column and a second inlet configure to introduce steam into the atmospheric distillation column. The atmospheric distillation column can also include a first outlet in fluid communication with an overhead drum system configured to recover an overhead gas product comprising C₄₋ hydrocarbons from the atmospheric distillation column and recycle at least a portion of the overhead gas product to the atmospheric distillation column, a second outlet configured to recover a bottoms product from the atmospheric distillation column, and a third outlet located between the first and second outlet configured to recover a liquid hydrocarbon product from the atmospheric distillation column.

Optionally, the system or process can include heating a crude oil comprising at least 1000 parts per million by weight of a first filterable solid material in a furnace to produce the heated crude oil. Additionally, the heated crude oil can be into a first inlet of an atmospheric distillation column having an absolute pressure of at least 17 kPa, wherein a ratio of the partial pressure of C₅₊ hydrocarbons at the first inlet of the atmospheric distillation column to the absolute pressure of the atmospheric distillation column at the first inlet of the atmospheric distillation column is less than 0.8. Steam can be introduced into a second inlet of the atmospheric distillation column. The ratio of a mass flow rate of the steam introduced into the atmospheric distillation column to a mass flow rate of the headed crude oil introduced into the atmospheric distillation column can be less than 0.05. An overhead gas product comprising C₄₋ hydrocarbons can be recovered from a first outlet of the atmospheric distillation column. An asphalt product can be recovered from a second outlet of the atmospheric distillation column and a liquid hydrocarbon product having less than 500 parts per million by weight of the filterable solid material can be recovered from a third outlet of the atmospheric distillation column. The third outlet can be located between the first and second outlet.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGURE schematically shows an example of a system upgrading a crude oil by recycling an overhead gas product to an atmospheric distillation column, according to an aspect of the invention.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

As used herein, and unless otherwise specified, the term “Cₙ” means hydrocarbon(s) having n carbon atom(s) per molecule, where n is a positive integer. Likewise, a “Cₘ-C_{y}” group or compound refers to a group or compound comprising carbon atoms at a total number thereof in the range from m to y. Thus, a C₁-C₄ hydrocarbon refers to a hydrocarbon that includes carbon atoms at a total number thereof in the range of 1 to 4, e.g., 1, 2, 3 and 4. A Cₘ₊ group or compound refers to a group or compound comprising carbon atoms at a total number thereof greater than or equal to m. A Cₘ₋ group or compound refers to a group or compound comprising carbon atoms at a total number thereof less than or equal to m.

As used herein, unless otherwise specified, “T5 boiling point” refers to a temperature at which 5 wt % of the feed, effluent, product, stream, or composition of interest will boil. In some examples, the T5 boiling point can be measured in accordance with ASTM D7169-18.

As used herein, unless otherwise specified, “T95 boiling point” refers to a temperature at which 95 wt % of the feed, effluent, product, stream, or composition of interest will boil. In some examples, the T95 boiling point can be measured in accordance with ASTM D7169-18.

One of the challenges for distillation of hydrocarbon feeds containing heavy components is achieving a desirable separation while reducing or minimizing cracking and/or coking of the feed. Atmospheric distillation is usually considered to be suitable for distillation of fractions up to about 343° C. to about 700° F. 70° C. Any portions of a feed boiling above about 343° C., or above about 370° C., become an atmospheric bottoms fraction. Further conventional separation of such an atmospheric bottoms fraction is then performed by vacuum distillation, where total pressures of 30 kPa-a or less are used to allow further separation of the atmospheric bottoms fraction without requiring an increase in temperature.

Another challenge for distillation of hydrocarbon feeds containing heavy components is that pipelines generally require a product having a viscosity of 350 cSt or less at the pipeline reference temperature. Extremely heavy hydrocarbon feeds, such as oil sands, can have a viscosity of over 700,000 cSt at 15° C. To meet these pipeline specifications, the hydrocarbon feeds is typically diluted with a diluent. However, to meet the viscosity specifications, the density (API Gravity) often greatly exceeds the minimum target density of 19°.

Another challenge for distillation of hydrocarbon feeds containing heavy components is that these hydrocarbon feeds can have a significant number of metals and solids in the feed, which typically require metal and solids removal processes to be used when processing the feed.

It has been surprisingly and unexpectedly discovered that recycling at least a portion of the overhead gas product containing C₄₋ hydrocarbons to an atmospheric distillation column can reduce the partial pressure of the C₅₊ hydrocarbons in the distillation column allowing higher boiling point fractions of crude oil to be vaporized at a significantly lower temperature. In some examples, vaporizing higher boiling point fractions of crude oil at lower temperatures can allow a heavy hydrocarbons feed to be processed into a product meeting pipeline specification while minimizing or eliminating the loss of the crude product in the bottoms fraction due to processing to meet pipeline specification. In some examples, vaporizing higher boiling point fractions of crude oil at lower temperatures can also allow for the bottoms fraction to be used as an asphalt product without subjecting the bottoms fraction to vacuum distillation. Additionally or alternately, when processing a heavy hydrocarbon feed containing a significant amount of metals such as V and Ni and solid particles such as sands, a metals or solids removal process may not be necessary when the bottoms fraction is used as an asphalt product as the solids that are present in the heavy carbon feed can replace solids that are typically added to the asphalt product and the metals content of crude is too low to negatively impact asphalt quality.

Using overhead gas to allow for atmospheric separation of higher boiling compounds can potentially provide a variety of advantages. The reduction of the partial pressure of the C₅₊ hydrocarbons can be achieved while operating the distillation stage at pressures near atmospheric pressure, thereby avoiding the operational costs and complexity of a vacuum distillation tower. Additionally or alternately, the reduction of the partial pressure of the C₅₊ hydrocarbons can be achieved while maintaining steam at a partial pressure of 20 kPa or less at the heated crude oil inlet and/or while maintaining the rate of steam flow at 3.0 wt % or less of the weight of the hydrocarbon flow into the distillation stage. Traditional atmospheric distillation of crude oil feeds can include exposing the feed to steam and atmospheric pressures. The steam can be used to assist with heating the feed and/or to assist with volatilizing the lower boiling portions of the feed. Although steam is commonly available in refinery settings, at remote sites the use of steam may require additional transport of water to the remote site location. Additionally, the use of steam can produce sour water, which can be costly to remove and/or dispose. By using overhead gas, the reduction of the C₅₊ partial pressure can be achieved using a resource that is available from the feed being separated and does not produce sour water. In addition, steam condensation at atmospheric tower overhead pressure can release a high amount of energy into the air or cooling water. Using overhead gas can eliminate condensation and vaporization steps as it can typically be achieved with a boost in pressure by increasing the sizing of the overhead gas compressor.

### Crude Oil

The crude oil being upgraded in the atmospheric distillation can be any hydrocarbon that can be suitably upgraded by a process according to the present invention. In some examples, the crude oil feed can have an API gravity of less than 20°, less than 17°, of less than 15°, less than 13°, of less than 11°, or less than 10°. In some examples, the crude oil feed can contain at least 40 vol %, at least 50 vol %, or at least 60 vol % of material having an atmospheric T5 boiling point of at least 525° C. In some examples, the crude oil feed can contain at least 40 vol %, at least 50 vol %, or at least 60 vol % of material having an atmospheric T5 boiling point of at least 425° C. In some examples the crude oil feed can be bitumen. In some examples, the bitumen can be a heavy crude oil extracted from tar sands, commonly called tar sand bitumen, such as Athabasca tar sand bitumen obtained from Canada. In some examples, the crude oil feed can be heavy petroleum crude oils such as Venezuelan Orinoco heavy oil or belt crudes such as Boscan heavy oil. In some examples, the crude oil feed can be heavy hydrocarbon fractions obtained from crude petroleum oils, such as heavy vacuum gas oils, or vacuum residuum. Other examples of heavy hydrocarbon feedstocks which can be used as the crude oil feed are oil shale, shale oil, asphaltenes, petroleum tar, tar sands and coal tar.

In some examples, the crude oil can include at least 500, at least 750, at least 1000, at least 1250, or at least 1500 parts per million by weight of a filterable solid material. In some examples, the crude oil can include 500 parts per million to 5000 parts per million, 500 parts per million to 7000 parts per million, 500 parts per million to 10,000 parts per million, 500 parts per million to 15,000 parts per million, 1000 parts per million to 5000 parts per million, 1000 parts per million to 7000 parts per million, 1000 parts per million to 10,000 parts per million, 1000 parts per million to 15,000 parts per million by weight of a filterable solid material. In some examples, the crude oil can contain free water or water in emulsion form. The water content can be vaporized in the heater and act as steam for assisting in lower the boiling point of some of the heavier crude components so that they can be converted into a pipelineable crude product.

### Fractionation of the Crude Oil Feed: Atmospheric Distillation Column

As discussed above, in various aspects, the crude oil feed can be subjected to atmospheric distillation where at least a portion of the overhead gas product is recycled to the atmospheric distillation column.

In some examples, the feed can be subjected to atmospheric distillation in an atmospheric distillation column. In some examples, the atmospheric distillation column can include alternating zones or series of packings or other internal structures for fractionation of the feed. The locations of the packings or other internal structures and/or their spacing can be positioned to optimize recovery of various fractions of the feed. In some examples, other internal structures can include random packings, structured packings grids, liquid or vapor distributors, and/or liquid and vapor collectors. The atmospheric distillation column can also include other typical fractionator parts and/or features, such as a flash zone. Further, the atmospheric distillation column can include a plurality of fractionation outlets for removing a portion of the feed. In addition, the atmospheric distillation column can be in fluid communication with various strippers and heaters as discussed below.

In one or more examples, the feed can be heated prior to entering the atmospheric distillation column. For example, the crude oil feed can be heated to a temperature of at least 250° C., at least 275° C., at least 300° C. or at least 350° C. In the same or alternative examples, the crude oil feed can be heated to a temperature of 500° C. or less, 400° C. or less, 380° C. or less, or 360° C. or less. In certain examples, the crude oil feed can be heated to a temperature of 250° C. to 500° C.; a temperature of 250° C. to 380° C.; a temperature of 250° C. to 360° C.; a temperature of 275° C. to 400° C.; a temperature of 275° C. to 380° C.; a temperature of 275° C. to 360° C.; a temperature of 300° C. to 400° C.; a temperature of 300° C. to 380° C.; or a temperature of 300° C. to 360° C., a temperature of 350° C. to 500° C.; a temperature of 350° C. to 450° C.; or a temperature of 350° C. to 400° C. In one or more examples, the crude oil feed can be heated in a conventional refinery furnace at or above atmospheric pressure. In certain aspects, such a furnace can be in fluid communication with the atmospheric distillation column, e.g., at the flash zone of the column. In some examples, the furnace can be heated to a temperature of at least 250° C., at least 275° C., at least 300° C. or at least 350° C. In the same or alternative examples, the furnace can be heated to a temperature of 500° C. or less, 400° C. or less, 380° C. or less, or 360° C. or less. In certain examples, the furnace can be heated to a temperature of 250° C. to 500° C.; a temperature of 250° C. to 380° C.; a temperature of 250° C. to 360° C.; a temperature of 275° C. to 400° C.; a temperature of 275° C. to 380° C.; a temperature of 275° C. to 360° C.; a temperature of 300° C. to 400° C.; a temperature of 300° C. to 380° C.; or a temperature of 300° C. to 360° C., a temperature of 350° C. to 500° C.; a temperature of 350° C. to 450° C.; or a temperature of 350° C. to 400° C.

In one or more examples, the heated crude oil feed can be introduced into a flash zone of the atmospheric distillation column, where the feed is exposed to atmospheric pressure.

In some examples, the atmospheric distillation column can have a pressure at the heated crude oil feed inlet of 17 kPa-a or more, or 25 kPa-a or more, or 80 kPa-a or more, or 100 kPa-a or more, or 150 kPa-a or more, or 200 kPa-a or more, or 250 kPa-a or less, or 300 kPa-a or more. For example, the atmospheric distillation column can have a pressure at the heated crude oil feed inlet of 17 kPa-a to 300 kPa-a, or 17 kPa-a to 250 kPa-a, or 17 kPa-a to 200 kPa-a, or 17 kPa-a to 150 kPa-a, or 17 kPa-a to 300 kPa-a, or 80 kPa-a to 250 kPa-a, or 80 kPa-a to 200 kPa-a, or 80 kPa-a to 150 kPa-a, or 100 kPa-a to 300 kPa-a, or 100 kPa-a to 250 kPa-a, 100 kPa-a to 200 kPa-a, or 100 kPa-a to 150 kPa-a, or 30 kPa-a to 60 kPa-a. In some examples, the atmospheric distillation column can have a pressure at the top of the of the atmospheric distillation column of 17 kPa-a or more, or 25 kPa-a or more, 80 kPa-a or more, or 100 kPa-a or more, or 150 kPa-a or more, or 200 kPa-a or more, or 250 kPa-a or less, or 300 kPa-a or more. For example, the atmospheric distillation column can have a pressure at the top of the of the atmospheric distillation column of 17 kPa-a to 300 kPa-a, or 17 kPa-a to 250 kPa-a, or 17 kPa-a to 200 kPa-a, or 17 kPa-a to 150 kPa-a, or 17 kPa-a to 300 kPa-a, or 80 kPa-a to 300 kPa-a, or 80 kPa-a to 250 kPa-a, or 80 kPa-a to 200 kPa-a, or 80 kPa-a to 150 kPa-a, or 100 kPa-a to 300 kPa-a, or 100 kPa-a to 250 kPa-a, 100 kPa-a to 200 kPa-a, or 100 kPa-a to 150 kPa-a, or 30 kPa-a to 60 kPa-a.

In some examples, in the atmospheric distillation column, the crude oil feed can be fractionated into, at least, a plurality of products. In such aspects, the atmospheric distillation column can be operated by one skilled in the art to control the cut points for obtaining the desired fractions withdrawn from the column.

Below, various fractions are described and discussed with regard to further processing in the fractionation. It should be appreciated that the fractions discussed below are only exemplary and any number of fractions can be obtained.

### Fractionation of the Crude Oil Feed: Bottoms Product

Once the crude oil feed enters the flash zone of the atmospheric distillation column, a portion of the heated crude oil feed may not vaporize and can be eluted from the column as liquid bottoms. In such aspects, at least a portion of the bottoms product may be withdrawn from the atmospheric distillation column. In some examples, the bottoms product can have an atmospheric T5 boiling point of at least 300° C., or at least 350° C. In some examples, the bottoms product can have an atmospheric T5 boiling point of 300° C. to 450° C., 300° C. to 500° C., 300° C. to 550° C., 350° C. to 450° C., 350° C. to 500° C., 350° C. to 550° C., 400° C. to 450° C., 400° C. to 500° C., or 400° C. to 550° C. In some examples, the bottoms product can have an atmospheric T95 boiling point of 600° C. or less, or 550° C. or less, or 500° C. or less.

In some examples, steam can be added to the atmospheric distillation column. In some examples, the steam can be added to the atmospheric distillation column through an inlet that is located below the heated crude feed inlet. In some examples, the steam can remove lighter components from the bottoms fraction through a process typically referred to as “stripping”. In some examples, the ratio of the mass flow rate of steam introduced into the atmospheric distillation column to the mass flow rate of the heated crude oil introduced into the atmospheric distillation column can be 0.001 to 0.01, 0.001 to 0.02, 0.001 to 0.03, 0.001 to 0.04, 0.001 to 0.05, 0.003 to 0.01, 0.003 to 0.02, 0.003 to 0.03, 0.003 to 0.04, 0.003 to 0.05, 0.005 to 0.01, 0.005 to 0.02, 0.005 to 0.03, 0.001 to 0.04, or 0.005 to 0.05. In some examples, the ratio of the mass flow rate of steam introduced into the atmospheric distillation column to the mass flow rate of the heated crude oil introduced into the atmospheric distillation column can be less than 0.05, 0.04, 0.03, 0.02, or 0.01.

In some examples, the partial pressure of the steam at the heated crude oil inlet can be less than 20 kPa, less than 15 kPa, or less than 10 kPa. In some examples, the partial pressure of the steam at the top of the atmospheric distillation column can be 20 kPa, less than 15 kPa, or less than 10 kPa.

In some examples, at least a portion of the bottoms product can be passed into a heater in a reboiler loop, in order to remove and/or vaporize at least a portion of the light products therein and return them to the atmospheric distillation column. The reboiler loop can be any conventional reboiler loop used in oil refineries. In some examples, the reboiler loop can be in fluid communication with the atmospheric distillation column, e.g., such that the vaporized products can be returned to a position in the atmospheric distillation column that is approximately close to the bottom of a set of packings or other internal structures used for condensation of the vaporized feed. In some examples, the set of packings or other internal structures used for condensation of the vaporized feed can be sieve trays or disc trays or donut trays, which all can help reduce fouling.

In some examples, the bottoms product can include an asphalt product. In one or more examples, the bottoms product can be utilized as an asphalt product to produce a pavement. In some examples, the asphalt product can meet roofing asphalt qualities including viscosity, hardness, and flashpoint. Asphalt quality specifications can depend on the region and its end use. However, operations of the atmospheric tower can ensure meeting important specifications such as viscosity and flash point by adjusting temperature, pressure, number of trays, light hydrocarbons recycle, or steam injections rates. The choice of crude oil can ensure sufficient asphaltene and resin content crude to provide sufficient hardness and other desirable qualities. In some examples, the bottoms product can include at least 500, at least 750, at least 1000, at least 1250, or at least 1500 parts per million by weight of a filterable solid material. In some examples, the bottoms product can include 500 parts per million to 5000 parts per million, 500 parts per million to 7000 parts per million, 500 parts per million to 10,000 parts per million, 500 parts per million to 15,000 parts per million, 1000 parts per million to 5000 parts per million, 1000 parts per million to 7000 parts per million, 1000 parts per million to 10,000 parts per million, 1000 parts per million to 15,000 parts per million by weight of a filterable solid material. In some examples, during production of the asphalt product, the pressure at the top of the distillation column producing the bottoms product containing the asphalt product can be at least 17 kPa or at least 50 kPa. In some examples, the asphalt product can be produced without using a vacuum distillation column.

In some examples, various additives can be added to the asphalt product. Non-limiting examples of suitable additives include viscosity control agents, lubricity agents, flowability agents, colorants, reinforcing agents, waxes, fibers, matting, tall oil, corn oil, gas oil, fabric, surfactants, wettability agents, anti-skid agents, reflective additives, cross-linking agents, anti-strip agents, emulsifier, mineral additives, fillers, polymers, aqueous solutions, anti-foaming agents, dispersing agents, mixing agents, compatibilizers, water repellents, reflective agents, UV light stabilizers, solvent resistant agents, herbicides, insecticides, anti-mold/fungal agents, and antibacterial agents. Each of these various additives can be present in the range of about 0.1 to about 35 wt % based on the weight of the asphalt material.

### Fractionation of the Crude Oil Feed: Pipelineable Liquid Fractions

As the heated crude oil feed enters the flash zone of the atmospheric distillation column, at least a portion of the feed can be vaporized and travel up through the column where a portion may condense on a set of packings or other internal structures. In various aspects, a fraction, e.g., a stream lighter than the bottoms, can be withdrawn from the atmospheric distillation column at one or more fractionation outlets in the column based on the desired end product or fraction. In certain aspects, this fraction can be withdrawn from a position near or below the reflux internals, a set of packings or other internal structures used for condensation of the vaporized feed.

In some examples, any convenient number of crude oil fractions can be withdrawn from the column in order to produce a desired slate of products. Examples of potential fractions can include, but are not limited to, naphtha, kerosene, light gas oil, and heavy gas oil. In some examples, the atmospheric distillation column can be configured to provide a withdrawn liquid fraction resulting in a pipelineable product. In some examples, the withdrawn liquid fraction can include less than 500 parts per million, or less than 250 parts per million by weight of a filterable solid material. In some examples, the withdrawn liquid fraction can have an API gravity of 19° or higher. In some examples, the withdrawn liquid fraction can have a kinematic viscosity at 100° of 350 cSt or less as measured by ASTM D445-18.

In some examples, the withdrawn liquid fraction can be subjected to a stripper in order to return any lighter or lower boiling point products to the atmospheric distillation column.

In some examples, the stripper can be any conventional stripper used in a fractionation system found at an oil refinery. In one or more examples, the stripper can include a vessel having a single set of packings or other internal structures for separating a lighter portion of the effluent stream to return to the atmospheric distillation column. In such aspects, the withdrawn liquid fraction may enter the stripper at a position near the top of, or above, the set of packings or other internal structures positioned in the stripper.

In some examples, the withdrawn liquid fraction that enters the stripper can flow down through the set of packings or other internal structures and can be exposed to a stripper medium moving up the stripper, such as a heated vapor stream. This stripper medium can heat the withdrawn liquid fraction, which may cause some lighter portion of the withdrawn liquid fraction to vaporize and exit the top of the stripper, which is in fluid communication with the atmospheric distillation column, thereby allowing this vaporized portion to return to the atmospheric distillation column. In one or more examples, 1% to 20% of the withdrawn liquid fraction that entered the stripper may become vaporized and return to the atmospheric distillation column. In some examples, the stripper can be located in the bottom section of the atmospheric distillation column.

In some examples, the stripper medium flowing through the stripper can be generated by heating (e.g., via a reboiler loop in fluid communication with the stripper) a portion of the withdrawn liquid fraction exiting the bottom of the stripper to form a heated vapor stream. In some examples, the stripper medium flowing through the stripper can be steam. In one or more aspects, this heated vapor stream may enter the bottom of the stripper just below the set of packings or other internal structures therein.

### Fractionation of the Crude Oil Feed: Overhead Gas Product

In some examples, a portion of the vaporized crude oil feed may not condense on any of the packings or other internal structures in the column and may exit the column as an overhead vapor stream, as discussed further below. In some examples, the overhead gas product can include C₄₋ hydrocarbons. In some examples, the overhead gas product can include at least 40 wt %, at least 50 wt %, at least 60 wt %, or at least 70 wt % of C₄₋ hydrocarbons based on the volume of the overhead gas product. In some examples, the overhead gas product can also include less than 50 wt %, less than 40 wt %, less than 30 wt % of C₅-C₈ hydrocarbons based on the volume of the overhead gas product. The overhead gas product can be recovered in an overhead drum system. A portion of the overhead gas product containing C₅-C₈ hydrocarbons can be condensed and recycled back to the atmospheric distillation column as a liquid to assist in the separation of the components in the column. In some examples, the ratio of a mass flow rate of the overhead gas recycled to the atmospheric distillation column to a mass flow rate of the heated crude oil introduced into the atmospheric distillation column is 0.2 to 0.6, 0.2 to 0.5, or 0.2 to 0.4. In some examples, at least a portion of the overhead gas product containing C₅-C₈ hydrocarbons can be condensed and mixed with other withdrawn liquid fractions. In some examples, a portion of the overhead gas product containing C₄₋ hydrocarbons can be recycled back to the atmospheric distillation column. In some examples, a blower can move the overhead gas product containing C₄₋ hydrocarbons from the overhead drum system to the atmospheric distillation column. In some examples, the overhead gas product containing C₄₋ hydrocarbons recycled back to the atmospheric distillation column enters the atmospheric distillation column below the heated crude oil feed inlet. In some examples, the overhead gas product containing C₄₋ hydrocarbons recycled back to the atmospheric distillation column is mixed with the crude oil or heated crude oil prior to entering the atmospheric distillation column. In some examples, the overhead gas product containing C₄₋ hydrocarbons can be recycled back to the atmospheric distillation column and mixed with the crude oil, the heated crude oil, or a combination thereof. In some examples, the overhead gas product containing C₄₋ hydrocarbons can be recycled back to the atmospheric distillation column and mixed with the crude oil, the heated crude oil, or a combination thereof in the furnace. In some examples, C₄₋ hydrocarbons can be removed from the recycled overhead gas product before e before the overhead gas product is recycled back to the atmospheric distillation column. Excess C₄₋ hydrocarbons can be burned as fuel gas. In some examples, additional fuel gas or other gases containing C₄₋ hydrocarbons can be added to the overhead gas product before the overhead gas product is recycled back to the atmospheric distillation column. In some examples, the mass flow rate of the recycled overhead gas product into the atmospheric distillation column can be adjusted to create a desired C₅₊ hydrocarbon partial pressure in the atmospheric distillation column. In some examples, the mass flow rate of the recycled overhead gas product into the atmospheric distillation column can be adjusted through the addition or removal of C₄₋ hydrocarbons from the recycled overhead gas product.

In some examples, the C₄₋ partial pressure in the atmospheric distillation column at the heated crude inlet can be from 1 kPa to 20 kPa, 20 kPa to 30 kPa. In some examples, the C₄₋ partial pressure in the atmospheric distillation column at the heated crude oil inlet can be at least 3 kPa, at least 4 kPa, or at least 5 kPa. In some examples, the C₄₋ partial pressure in the atmospheric distillation column at the top of the atmospheric distillation column can be from 4 kPa to 7 kPa

### Example of Atmospheric Distillation System Configuration

FIGURE depicts one example of a distillation system 100 for fractionating a crude oil feed.

Initially, a crude oil feed 102 can be heated in a furnace 104, such as within the temperature range discussed above. In such aspects, the heated crude oil feed 106 enters the flash zone of an atmospheric distillation column 108. The atmospheric distillation column 108 can include one or more of the properties and parameters discussed above. For example, in one aspect, the column 108 can include a series 110 of packings and/or other internal structures. The flash zone may be located below the packings 110.

In various aspects, once the heated crude oil feed 106 enters the column 108, a portion of the heated crude oil feed 106 may vaporize and travel up the column 108. A portion of the heated crude oil feed 106 does not vaporize and ends up as a liquid bottom fraction 112 that exits the bottom of the column 108. In some examples, stripper steam 113 can enter the column 108 to remove lighter components from the liquid bottom fraction 112. In some examples, the resulting liquid bottom fraction 112 can be an asphalt product 114 which can be railed, barged or trucked to the customers.

In some examples, the vaporized portion of the heated crude oil feed 106 travels up the column 108 and may condense, for example, on the packing or other internal set 110 and exit the column 108 as an effluent stream 116 which can be transported as high quality light and bottomless crude through pipelines or processed to various finished products such as gasoline and distillate.

In some examples, a portion of the vaporized feed that does not condense on any structures within the column 108 can exit the column 108 as an overhead fraction 118 that is sent to an overhead drum system 120. The overhead drum system 120 recycles a portion of the overhead fraction containing C₄₋ hydrocarbons 122 to the column 108 through stream 123 to reduce the partial pressure of the C₅₊ hydrocarbons in the column 108. Alternatively, natural gas can be added to the overhead fraction. In some examples, a portion of the overhead fraction can be sent to the heater to be used as fuel.

Embodiment 1. A process comprising: heating a crude oil in a furnace to produce a heated crude oil; introducing the heated crude oil into a first inlet of an atmospheric distillation column having an absolute pressure of at least 17 kPa; recovering an overhead gas product comprising C₄₋ hydrocarbons from a first outlet of the atmospheric distillation column and recycling at least a portion of the overhead gas product to the atmospheric distillation column; recovering a bottoms product from a second outlet of the atmospheric distillation column, recovering a liquid hydrocarbon product from a third outlet of the atmospheric distillation column, wherein the third outlet is located between the first and second outlet.

Embodiment 2. The process of Embodiment 1, wherein a partial pressure of C₄₋ hydrocarbons at the first inlet of the atmospheric distillation column is at least 30 kPa.

Embodiment 3. The process of any of the above embodiments, wherein a partial pressure of C₅₊ hydrocarbons at the first inlet of the atmospheric distillation column is less than 50 kPa.

Embodiment 4. The process of any of the above embodiments, wherein a ratio of the partial pressure of C₅₊ hydrocarbons at the first inlet of the atmospheric distillation column to the absolute pressure of the atmospheric distillation column at the first inlet of the atmospheric distillation column is less than 0.8.

Embodiment 5. The process of any of the above embodiments, wherein the bottoms product is an asphalt product.

Embodiment 6. The process of any of the above embodiments, wherein the bottoms products comprises at least 1000 parts per million by weight of a first filterable solid material.

Embodiment 7. The process of any of any of the above embodiments, further comprising introducing steam into a second inlet of the atmospheric distillation column.

Embodiment 8. The process of any of any of the above embodiments, wherein the second inlet is located between the first inlet and the second outlet.

Embodiment 9. The process of any of any of the above embodiments, wherein the overhead gas comprises at least 60 wt % C₄₋ hydrocarbons by weight of the overhead gas.

Embodiment 10. The process of any of any of the above embodiments, wherein a ratio of a mass flow rate of the overhead gas recycled to the atmospheric distillation column to a mass flow rate of the heated crude oil introduced into the atmospheric distillation column is 0.2 to 0.6.

Embodiment 11. The process of any of any of the above embodiments, wherein a ratio of a mass flow rate of steam introduced into the atmospheric distillation column to a mass flow rate of the heated crude oil introduced into the atmospheric distillation column is 0.003 to 0.03.

Embodiment 12. The process of any of any of the above embodiments, wherein an atmospheric T5 boiling point of the bottoms product is at least 450° C.

Embodiment 13. The process of any of any of the above embodiments, wherein the furnace is heated to a temperature of 350° C. to 500° C.

Embodiment 14. The process of any of any of the above embodiments, wherein the liquid hydrocarbon product comprises less than 500 parts per million by weight of a second filterable solid material.

Embodiment 15. The process of any of any of the above embodiments, wherein recycling at least a portion of the overhead gas product to the atmospheric distillation column comprises mixing the overhead gas with the crude oil, the heated crude oil, or a combination thereof.

Embodiment 16. The process of any of any of the above embodiments, wherein recycling at least a portion of the overhead gas product to the atmospheric distillation column comprises recycling at least a portion of the overhead gas product to a third inlet of the atmospheric distillation column located between the first inlet and the second outlet of the atmospheric distillation column.

Embodiment 17. A system for the fractionation of a crude oil, comprising: an atmospheric distillation column having an absolute operating pressure of 17 kPa or more, the atmospheric distillation column comprising, a first inlet in fluid communication with a furnace configured to introduce a heated crude oil into the atmospheric distillation column, a second inlet configure to introduce steam into the atmospheric distillation column, a first outlet in fluid communication with an overhead drum system configured to recover an overhead gas product comprising C₄₋ hydrocarbons from the atmospheric distillation column and recycle at least a portion of the overhead gas product to the atmospheric distillation column, a second outlet configured to recover a bottoms product from the atmospheric distillation column, and a third outlet located between the first and second outlet configured to recover a liquid hydrocarbon product from the atmospheric distillation column.

Embodiment 18. The system of Embodiment 17, wherein a partial pressure of C₅₊ hydrocarbons at the first inlet of the atmospheric distillation column is less than 50 kPa.

Embodiment 19. The system of any of Embodiment 17 or Embodiment 18, wherein a ratio of the partial pressure of C₅₊ hydrocarbons at the first inlet of the atmospheric distillation column to the absolute pressure of the atmospheric distillation column at the first inlet of the atmospheric distillation column is less than 0.8.

Embodiment 20. The system of any of Embodiments 17 to 19, wherein the bottoms product is an asphalt product.

Embodiment 21. The system of any of Embodiments 17 to 20, wherein the bottoms products comprise at least 1000 parts per million by weight of a first filterable solid material.

Embodiment 22. The system of Embodiment 21, wherein the bottoms products comprises to 1000 to 10000 parts per million by weight of the first filterable solid material.

Embodiment 23. The system of any of Embodiments 17 to 22, wherein the overhead gas comprises at least 60 wt % C₄₋ hydrocarbons by weight of the overhead gas.

Embodiment 24. The system of any of Embodiments 17 to 23, wherein a ratio of a mass flow rate of the overhead gas mixed with the additional crude in the furnace to a mass flow rate of the heated crude oil introduced into the atmospheric distillation column is 0.2 to 0.6.

Embodiment 25. The system of any of Embodiments 17 to 24, wherein a ratio of a mass flow rate of steam introduced into the atmospheric distillation column to a mass flow rate of the heated crude oil introduced into the atmospheric distillation column is 0.003 to 0.03.

Embodiment 26. The system of any of Embodiments 17 to 25, wherein an atmospheric T5 boiling point of the bottoms product is at least 450° C.

Embodiment 27. The system of any of Embodiments 17 to 26, wherein the furnace is heated to a temperature of 350° C. to 500° C.

Embodiment 28. The system of any of Embodiments 17 to 27, wherein the liquid hydrocarbon product comprises less than 500 parts per million by weight of a second filterable solid material.

Embodiment 29. The system of any of Embodiments 17 to 28, wherein the second inlet is located between the first inlet and the second outlet.

Embodiment 30. The system of any of Embodiments 17 to 29, wherein the atmospheric distillation column further comprises a third inlet in fluid communication with the overhead drum system configured to introduce at least a portion of the recycled overhead gas product comprising C₄₋ hydrocarbons into the atmospheric distillation column.

Embodiment 31. The system of any of Embodiments 17 to 30, wherein the third inlet is located between the first inlet and the second outlet.

Embodiment 32. A process comprising: heating a bitumen comprising at least 1000 parts per million by weight of a first filterable solid material in a furnace to produce a heated bitumen; introducing the heated bitumen into a first inlet of an atmospheric distillation column having an absolute pressure of at least 17 kPa; recovering an overhead gas product comprising C₄₋ hydrocarbons from a first outlet of the atmospheric distillation column and recycling at least a portion of the overhead gas product to the atmospheric distillation column; recovering a bottoms product from a second outlet of the atmospheric distillation column, recovering a liquid hydrocarbon product from a third outlet of the atmospheric distillation column, wherein the third outlet is located between the first and second outlet.

Embodiment 33. The process of Embodiment 32, wherein a partial pressure of C₄₋ hydrocarbons at the first inlet of the atmospheric distillation column is at least 30 kPa.

Embodiment 34. The process of Embodiment 32 or Embodiment 33, wherein a partial pressure of C₅₊ hydrocarbons at the first inlet of the atmospheric distillation column is less than 50 kPa.

Embodiment 35. The process of any of Embodiments 32 to 34, wherein a ratio of the partial pressure of C₅₊ hydrocarbons at the first inlet of the atmospheric distillation column to the absolute pressure of the atmospheric distillation column at the first inlet of the atmospheric distillation column is less than 0.8.

Embodiment 36. The process of any of Embodiments 32 to 35, wherein the bottoms product is an asphalt product.

Embodiment 37. The process of any of Embodiments 32 to 36, further comprising introducing steam into a second inlet of the atmospheric distillation column.

Embodiment 38. The process of any of Embodiments 32 to 37, wherein the second inlet is located between the first inlet and the second outlet.

Embodiment 39. The process of any of Embodiments 32to 38, wherein the overhead gas comprises at least 60 wt % C₄₋ hydrocarbons by weight of the overhead gas.

Embodiment 40. The process of any of Embodiments 32 to 39, wherein a ratio of a mass flow rate of the overhead gas recycled to the atmospheric distillation column to a mass flow rate of the heated crude oil introduced into the atmospheric distillation column is 0.2 to 0.6.

Embodiment 41. The process of any of Embodiments 32 to 40, wherein a ratio of a mass flow rate of steam introduced into the atmospheric distillation column to a mass flow rate of the heated bitumen introduced into the atmospheric distillation column is 0.003 to 0.03.

Embodiment 42. The process of any of Embodiments 32 to 41, wherein an atmospheric T5 boiling point of the bottoms product is at least 450° C.

Embodiment 43. The process of any of Embodiments 32 to 42, wherein the furnace is heated to a temperature of 350° C. to 500° C.

Embodiment 44. The process of any of Embodiments 32 to 43, wherein the liquid hydrocarbon product comprises less than 500 parts per million by weight of a second filterable solid material.

Embodiment 45. The process of any of Embodiments 32 to 44, wherein recycling at least a portion of the overhead gas product to the atmospheric distillation column comprises mixing the overhead gas with the bitumen, the heated bitumen, or a combination thereof.

Embodiment 46. The process of any of Embodiments 32 to 45, wherein recycling at least a portion of the overhead gas product to the atmospheric distillation column comprises recycling at least a portion of the overhead gas product to a third inlet of the atmospheric distillation column located between the first inlet and the second outlet of the atmospheric distillation column.

Embodiment 47. The process of any of Embodiments 32 to 46, wherein the bitumen comprises at least 50 vol % of a material having an atmospheric T5 boiling point of at least 525° C.

Embodiment 48. The process of any of Embodiments 32 to 47, wherein the bitumen is tar sands bitumen.

Embodiment 49. A process comprising: heating a crude oil comprising at least 1000 parts per million by weight of a filterable solid material in a furnace to produce a heated crude oil; introducing the heated crude oil into a first inlet of an atmospheric distillation column having an absolute pressure of at least 17 kPa, wherein a ratio of the partial pressure of C₅₊ hydrocarbons at the first inlet of the atmospheric distillation column to the absolute pressure of the atmospheric distillation column at the first inlet of the atmospheric distillation column is less than 0.8; introducing steam into a second inlet of the atmospheric distillation column wherein the ratio of a mass flow rate of the steam introduced into the atmospheric distillation column to a mass flow rate of the headed crude oil introduced into the atmospheric distillation column is less than 0.05; recovering an overhead gas product comprising C₄₋ hydrocarbons from a first outlet of the atmospheric distillation column; recovering an asphalt product from a second outlet of the atmospheric distillation column and recovering a liquid hydrocarbon product comprising less than 500 parts per million by weight of the filterable solid material from a third outlet of the atmospheric distillation column, wherein the third outlet is located between the first and second outlet.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A process comprising:
heating one of a crude oil and bitumen in a furnace to produce one of a heated crude oil and heated bitumen;
introducing one of the heated crude oil and heated bitumen into a first inlet of an atmospheric distillation column having an absolute pressure of at least 17 kPa;
recovering an overhead gas product comprising C₄₋ hydrocarbons from a first outlet of the atmospheric distillation column and recycling at least a portion of the overhead gas product to the atmospheric distillation column;
recovering a bottoms product from a second outlet of the atmospheric distillation column,
recovering a liquid hydrocarbon product from a third outlet of the atmospheric distillation column, wherein the third outlet is located between the first and second outlet.

2. The process of claim 1, wherein a partial pressure of C₄₋ hydrocarbons at the first inlet of the atmospheric distillation column is at least 30 kPa, wherein a partial pressure of C₅₊ hydrocarbons at the first inlet of the atmospheric distillation column is less than 50 kPa.

3. The process of claim 1, wherein a ratio of the partial pressure of C₅₊ hydrocarbons at the first inlet of the atmospheric distillation column to the absolute pressure of the atmospheric distillation column at the first inlet of the atmospheric distillation column is less than 0.8.

4. The process of claim 1, wherein the bottoms products comprises at least 1000 parts per million by weight of a first filterable solid material.

5. The process of claim 1, wherein the overhead gas comprises at least 60 wt % C₄₋ hydrocarbons by weight of the overhead gas.

6. The process of claim 1, wherein a ratio of a mass flow rate of the overhead gas recycled to the atmospheric distillation column to a mass flow rate of the heated crude oil introduced into the atmospheric distillation column is 0.2 to 0.6.

7. The process of claim 1, wherein a ratio of a mass flow rate of steam introduced into the atmospheric distillation column to a mass flow rate of the heated crude oil introduced into the atmospheric distillation column is 0.003 to 0.03.

8. The process of claim 1, wherein the liquid hydrocarbon product comprises less than 500 parts per million by weight of a second filterable solid material.

9. The process of claim 1, wherein recycling at least a portion of the overhead gas product to the atmospheric distillation column comprises mixing the overhead gas with one of the crude oil, the heated crude oil, or a combination thereof and the bitumen, heated bitumen or combination thereof.

10. The process of claim 1, wherein recycling at least a portion of the overhead gas product to the atmospheric distillation column comprises recycling at least a portion of the overhead gas product to a third inlet of the atmospheric distillation column located between the first inlet and the second outlet of the atmospheric distillation column.

11. The process of claim 1, wherein the bitumen is tar sands bitumen.

12. A system for the fractionation of a crude oil, comprising:
an atmospheric distillation column having an absolute operating pressure of 17 kPa or more, the atmospheric distillation column comprising,
a first inlet in fluid communication with a furnace configured to introduce a heated crude oil into the atmospheric distillation column,
a second inlet configure to introduce steam into the atmospheric distillation column,
a first outlet in fluid communication with an overhead drum system configured to recover an overhead gas product comprising C₄₋ hydrocarbons from the atmospheric distillation column and recycle at least a portion of the overhead gas product to the atmospheric distillation column,
a second outlet configured to recover a bottoms product from the atmospheric distillation column, and
a third outlet located between the first and second outlet configured to recover a liquid hydrocarbon product from the atmospheric distillation column.

13. The system of claim 10, wherein a ratio of the partial pressure of C₅₊ hydrocarbons at the first inlet of the atmospheric distillation column to the absolute pressure of the atmospheric distillation column at the first inlet of the atmospheric distillation column is less than 0.8.

14. The system of claim 10, wherein the bottoms products comprise at least 1000 parts per million by weight of a first filterable solid material.

15. The system of claim 10, wherein the overhead gas comprises at least 60 wt % C₄₋ hydrocarbons by weight of the overhead gas.

16. The system of claim 10, wherein a ratio of a mass flow rate of the overhead gas mixed with the additional crude in the furnace to a mass flow rate of the heated crude oil introduced into the atmospheric distillation column is 0.2 to 0.6.

17. The system of claim 10, wherein a ratio of a mass flow rate of steam introduced into the atmospheric distillation column to a mass flow rate of the heated crude oil introduced into the atmospheric distillation column is 0.003 to 0.03.

18. The system of claim 10, wherein the liquid hydrocarbon product comprises less than 500 parts per million by weight of a second filterable solid material.

19. The system of claim 10, wherein the atmospheric distillation column further comprises a third inlet in fluid communication with the overhead drum system configured to introduce at least a portion of the recycled overhead gas product comprising C₄₋ hydrocarbons into the atmospheric distillation column.

20. A process comprising:
heating a crude oil comprising at least 1000 parts per million by weight of a filterable solid material in a furnace to produce a heated crude oil;
introducing the heated crude oil into a first inlet of an atmospheric distillation column having an absolute pressure of at least 17 kPa, wherein a ratio of the partial pressure of C₅₊ hydrocarbons at the first inlet of the atmospheric distillation column to the absolute pressure of the atmospheric distillation column at the first inlet of the atmospheric distillation column is less than 0.8;
introducing steam into a second inlet of the atmospheric distillation column wherein the ratio of a mass flow rate of the steam introduced into the atmospheric distillation column to a mass flow rate of the headed crude oil introduced into the atmospheric distillation column is less than 0.05;
recovering an overhead gas product comprising C₄₋ hydrocarbons from a first outlet of the atmospheric distillation column;
recovering an asphalt product from a second outlet of the atmospheric distillation column and
recovering a liquid hydrocarbon product comprising less than 500 parts per million by weight of the filterable solid material from a third outlet of the atmospheric distillation column, wherein the third outlet is located between the first and second outlet.
